(19) United States
(12) Patent Application Publication
(10) Pub. No.: US 2015/0220868 A1
(43) Pub. Date: Aug. 6, 2015

(54) Evaluating Data Quality of Clinical Trials

(71) Applicant: Patient Profiles, LLC, New York, NY (US)

(72) Inventor: Michael Elashoff, Redwood Shores, CA (US)

(21) Appl. No.: 14/610,865

(22) Filed: Jan. 30, 2015

Related U.S. Application Data
(60) Provisional application No. 61/935,319, filed on Feb. 3, 2014.
(60) Provisional application No. 62/043,374, filed on Aug. 28, 2014.

(51) Int. Cl. G06Q 10/06; G06Q 50/22

(52) U.S. Cl. CPC G06Q 10/06395; G06Q 50/22

(57) ABSTRACT

An analysis server obtains data associated with patients as part of a clinical trial. The analysis server derives models from the patient data, the models specifying how likely it is that a given value of a variable (or values of a pair of variables) are erroneous. The models can be applied to the patient data to identify variable values more likely to be erroneous, and in turn to assess the data quality of patients, sites, and the clinical trial itself.

### CROSS REFERENCE TO RELATED APPLICATIONS

The application claims the benefit of Provisional Application No. 61/935,319, Attorney Docket #30820-25122, filed on Feb. 3, 2014, and Provisional Application No. 62/043,374, Attorney Docket #30820-27649, filed on Aug. 28, 2014, both of which are hereby incorporated herein by reference.

### BACKGROUND

1. Field

The described embodiments generally relate to the field of digital data processing systems, and more specifically, to processing electronic patient records produced as part of clinical trials in order to quantify their data quality.

2. Description of the Related Art

Clinical trials typically collect an immense amount of patient data, such as demographics, medical history, lab values, adverse events such as illnesses, and the like. In many trials, there are hundreds or thousands of patients, each with patient data made up of values for thousands of associated variables.

The patient data is often input manually, e.g., by medical personnel or clerical workers. To avoid erroneous data, the input data is manually reviewed and verified for accuracy. However, such manual checks are time-consuming, and in the aggregate often account for 30% or more of the total cost of the clinical trial.

### SUMMARY

An analysis server obtains electronic patient data associated with patients as part of a clinical trial. The analysis server processes the patient data to derive a number of different of univariate and/or bivariate models specifying how likely it is that a given value of a variable (or values of a pair of variables) is erroneous (e.g., due to input errors). The models can be applied to the patient data to identify variable values more likely to be erroneous, and in turn to quantify the data quality of patients, sites, and the clinical trial itself.

### BRIEF DESCRIPTION OF DRAWINGS

FIG. 1 illustrates an environment in which patient data records are collected and analyzed, according to one embodiment.

FIG. 2 is a block diagram illustrating a detailed view of components of the analysis server of FIG. 1, according to one embodiment.

FIG. 3A is a data flow diagram illustrating a process of forming models for assessing likelihoods that errors are present in patient data, according to one embodiment.

FIG. 3B is a data flow diagram illustrating usage of the models of FIG. 3A to identify potential errors in patient data, according to one embodiment.

FIG. 4 illustrates a sample user interface according to one embodiment.

FIG. 5 is a block diagram illustrating various physical components of an example computer system that can serve as an analysis server according to one embodiment.

The figures depict various embodiments of the present invention for purposes of illustration only. One skilled in the art will readily recognize from the following description that other alternative embodiments of the structures and methods illustrated herein may be employed without departing from the principles of the invention described herein.

### DETAILED DESCRIPTION

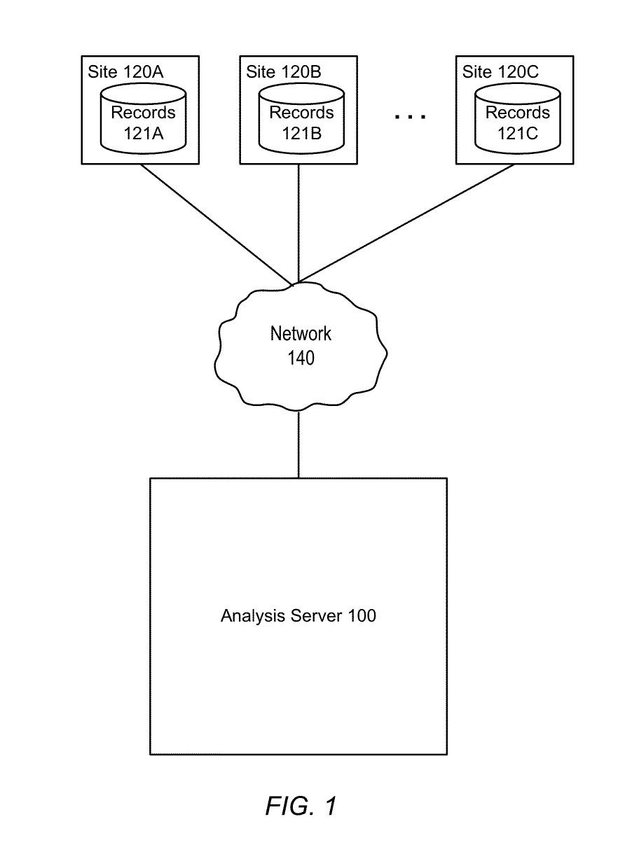

FIG. 1 illustrates a computing environment in which patient data records associated with a clinical trial are collected and analyzed, according to one embodiment. Different medical or data processing sites 120 collect patient data records 121 for the patients associated with the clinical trial. For example, one site 120A might be a medical office where employees collect patient intake information such as medical histories, manually producing records 121 by entering the intake information into a database. The site 120A might also review patient lab results collected during the clinical trial, manually entering the results. A clinical trial will commonly include many such sites (120A, 120B, 120C, etc.). Some portion of the entered data may also be automatically entered, such as by a medical device that automatically places patient data readings in a database.

The various patient records produced by the different sites 120 are provided to an analysis server 100, which analyzes the data and assesses the data quality of the records. More specifically, based on the data in the provided records, the analysis server 100 derives models for one or more variables in the patient records that indicate how likely it is that the data in one or more patient data records is accurate. The analysis server 100 can then apply the models to the patient data records to identify values of variables that have a comparatively high likelihood of containing inaccurate data. Manual data verification efforts can then be focused on these identified values, thereby greatly reducing the amount of manual effort required to ensure data quality. The analysis server 100 can additionally aggregate its findings from the level of individual values of patient data records to make higher-level observations, such as identifying sites 120 that produce greater than average numbers of errors, or assessing the current overall quality of patient data in the clinical trial to determine whether additional data still should be collected and verified, or whether the existing data is sufficient and the clinical trial need therefore collect no additional data.

Although three sites 120—site 120A, site 120B, and site 120C—are illustrated in FIG. 1, this is purely for the purpose of example, and there may be different numbers of sites 120 in different embodiments.

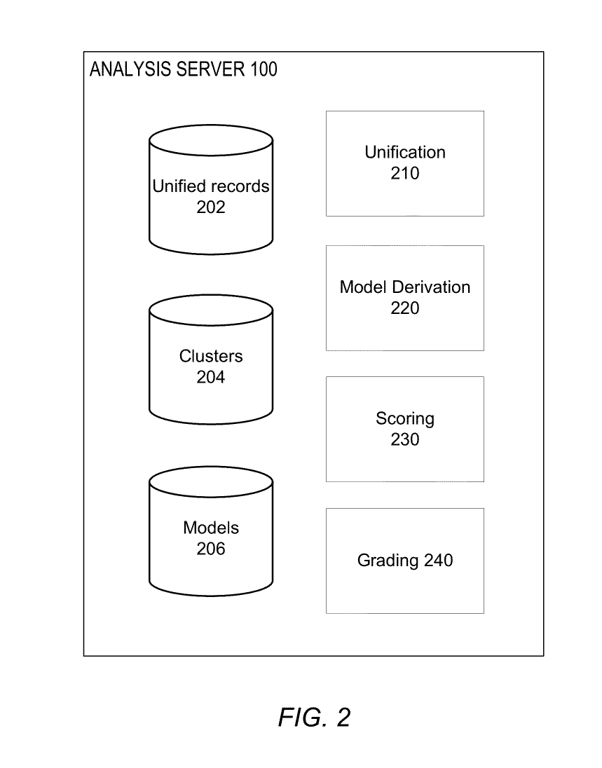

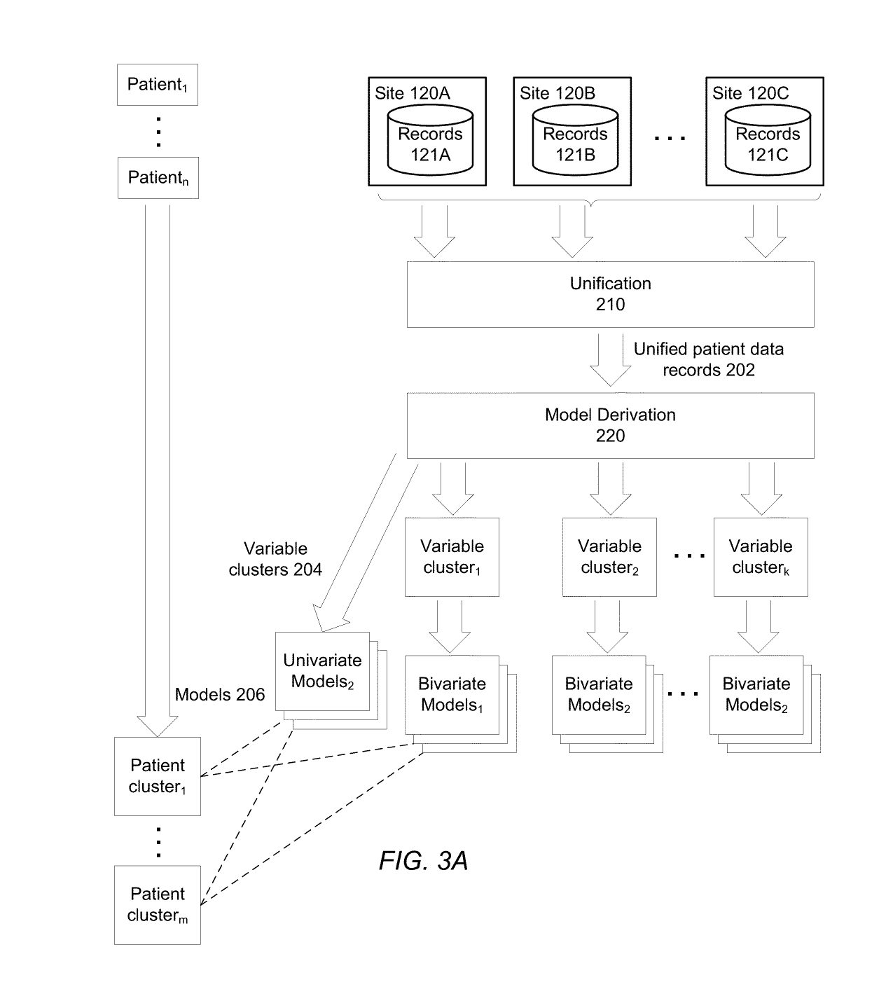

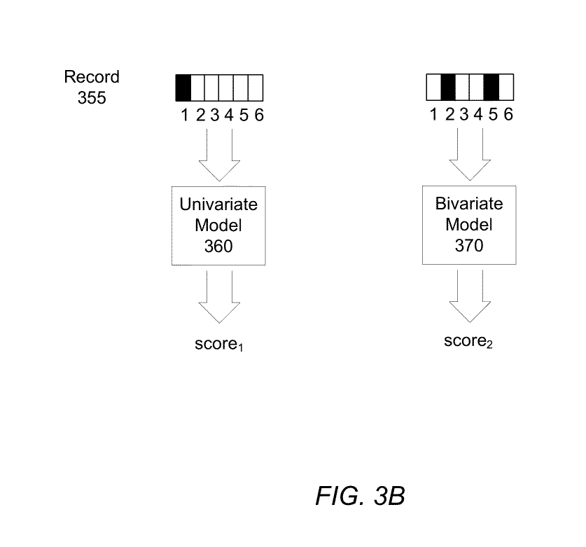

FIG. 2 is a block diagram illustrating a detailed view of components of the analysis server 100 of FIG. 1, according to one embodiment. A unification module 210 takes as input the various patient data records 121 of the sites 120 and produces a set of unified patient data records 202. A model derivation module 220 clusters the various variables of the patient data variables according to their observed similarities. The model derivation model 220 further derives a set of models 206,which when applied to variable values of a patient data record indicate whether those values likely are erroneous. A scoring module 230 applies the models 206 derived by the model derivation module 220 to variable values of patient data records of the unified records 202, the result for each data record being a score indicating whether the values are likely erroneous. A grading module 240 uses the scores produced by the scoring module 230 to assign a single intuitive grade to the clinical trial as a whole. Further detail on the operations of the modules 210-240 is now provided, and the operations are later illustrated in the context of the data flow diagrams of FIGS. 3A-3B.

Unification

The unification module 210 takes as input the various patient data records 121 of the sites 120 and produces a set of unified patient data records 202. In one embodiment, the patient data records 121 from the various sites use a patient ID to identify information as pertaining to a particular patient, and the unification module 210 uses that patient ID to join the information for that patient from the different sets of patient data records 121.

The different sets of data for a given patient are joined in different ways, depending on the nature of the data. For example, for a set of data with just one record per patient (e.g., height), the values of the variables within the set of data are simply joined to the other data for that patient (e.g., date of birth).

As another example, for event-based data sets (i.e., data describing events that can recur a number of times, such as doctor visits or adverse events such as sicknesses), which can have multiple records for a given patient, the various records are combined to list event counts for the various events. For example, input records of the format <patientID, eventType, eventDate>, such as the three records {<1, 2, 12/23/13 4:26:30 PM>, <1, 2, 1/26/14 2:05:00 PM>, <1, 3, 12/31/13 11:55:20 PM>} can be aggregated to a single record of the format <patientID, eventType₁, count₁, . . . eventTypeₙ, countₙ,>, such as the record <1, 1, 0, 2, 2, 3, 1>, indicating that the patient with the ID “1” had 0 events of type 1, 2 events of type 2, and 1 event of type 3.

As another example, for time series-based data sets (i.e., data describing events whose temporal relationships are significant, such as lab values or efficacy endpoints), which can have multiple records for a given patient, the various records are combined to group all the records for a patient. For example, input records of the format <patientID, measurementType, date, measurementValue>can be aggregated to a single record of the format <patientID, <measurementDataType₁>, . . . , <measurementDataTypeₙ>>, where there is a measurementDataTypeᵢ for every instance of a time event of that type, listing the time and the value of the time event. For example, the three records {<1, 2, 12/23/13 4:26:30 PM, 4>, <1, 2, 1/26/14 2:05:00 PM, 5>, <1, 3, 12/31/13 11:55:20 PM, 2>} could be aggregated to a single record <1, 2:<12/23/13 4:26:30 PM, 4; 1/26/14 2:05:00 PM, 5>, 3:<3, 12/31/13 11:55:20 PM, 2>>. Optionally, the variable number of time series data items for a given datatype can be further converted to a single set of representative data, such as a mean/slope describing a line that best fits the time series data items. In addition to these examples, other methodologies for joining patient data may be employed by the implementer.

In one embodiment, for each data set, a variable is added that represents the number of records that the given patient had within that data set. Thus, for example, if a patient had been taking five different medications, the patient would have five records in the medications dataset, and would have a value of <5> for the additional variable representing the medication count.

In one embodiment, additional preprocessing is used to make the data more amenable to statistical analysis. For example, dates can be converted to day numbers (e.g., as offsets with respect to the first day of the study), so that all patients are on the same time scale. As another example, variables that are constant for all patients are removed. As another example, variables that have a high missing fraction are recorded to missing/non-missing.

Model Derivation

The model derivation module 220 evaluates the patient data records in order to derive models for one or more corresponding variables that can be used to identify anomalous values of those variables. The models may be for a single variable (a “univariate” relationship), or for relationships of two or more variables (“bivariate” or “multivariate” relationships, respectively). The derivation of the models depends on the data types of the variables involved, such as numeric variables (e.g., continuous real numbers or discrete integers), binary variables (storing “0” or “1” or the logical equivalent thereof), and categorical variables (storing a value from a discrete set of possible values representing different categories with no direct quantifiable relationship between the values). Derivation of models of the different types of variable relationships is now described in more detail.

(A) Univariate Relationships

Univariate relationships capture the observed relationships of different values of a single variable (e.g., height) across a sample set of various patient data records. The model for a univariate relationship depends upon the type of the variable in question. In one embodiment, for every variable, one model is trained for the sample set of all the patient data records, and another model is trained for the sample set defined by each of a set of patient clusters. Clustering patients is described later below with respect to multivariate relationships.

(i) Categorical or Binary Variables

In one embodiment, the univariate model for a variable is the probability density function derived by analyzing the different values of the variable over the patient data records.

(ii) Continuous Numeric Variables

In one embodiment, the model is a normal distribution, where the mean and standard deviation of the normal distribution are the trimmed mean and trimmed standard deviation of the values of the variable over the patient data records. To ensure that the normal distribution function is appropriate, the Box-Cox transformation is used for the variable.

(iii) Discrete Numeric Variables

In one embodiment, the model is the best fitting statistical distribution estimated by maximum likelihood from the set of geometric, Poisson, negative binomial, and discrete lognormal distributions derived from the values of the variable over the patient data records.

(B) Bivariate Relationships

Bivariate relationships capture the relationships of pairs of variables, such as height and weight, observed over some set of patient data records. Variables with sufficiently strong relationships are clustered, and models are derived for variable pairs in the clusters. The models can then be applied to values of the corresponding variables to detect anomalous relationships (and, equivalently, the variable values of the variable pair that constitute the anomalous relationship). For example, height and weight might be two variables with a strong (linear) relationship, and a corresponding derived height-weight model could identify that a very large height with a very small weight is anomalous, and hence merits further investigation into both the height value and the weight value.

Specifically, the relationship strength between different variables is quantified using a distance metric between a first variable vᵢ and a second variable vⱼ. The type of distance metric employed depends upon the data types of the variables. In one embodiment, for example, the following distance metrics are used for variable pairs vᵢ and vⱼ:

| Data Type for Vi | Data Type for Vj | Distance Metric |
|---|---|---|
| Numeric | Numeric, | 1-abs(correlation) |
| | Asymmetric Binary, | |
| | Symmetric Binary | |
| Asymmetric Binary | Asymmetric Binary | 1-Jaccard index |
| Categorical, | Categorical, | 1-phi coefficient |
| Symmetric Binary | Asymmetric Binary, | |
| | Symmetric Binary | |
| Numeric | Categorical | 1-phi coefficient (after |
| | | quantizing the numeric |
| | | variable) |

The model derivation module 220 clusters the variables according to their respective distances as evaluated using the distance functions. In one embodiment, hierarchical clustering is used to group the variables, and the number of clusters for the variables is then estimated using (a) the reduction of within cluster distance as a function of cluster number, and (b) the stability of the clusters as a function of the distance threshold.

The model derivation module 220 derives a model for each pair of variables vᵢ and vⱼ in a cluster. The models take, as input, the values of vᵢ and vⱼ and output a score representing the degree of anomalousness of the pair of values occurring with the same patient data record. The type of model employed depends upon the types of the variables vᵢ and vⱼ. For example, in one embodiment the following model types are employed:

| Data Type | Data Type | |
|---|---|---|
| for Vi | for Vj | Model formation |
| Numeric | Numeric | Fit robust linear regression of vᵢ on vⱼ and a |
| | | robust linear regression of vⱼ on vᵢ, and select |
| | | as the model the better of the two. |
| Categorical | Categorical | Define the model based on cross tabulation |
| or Binary | or Binary | of the two variables. |
| Numeric | Binary | Define the model using a logistic regression |
| | | of vⱼ as a function of vᵢ. |
| Numeric | Categorical | Quantize vᵢ by quartile, and then define |
| | | the model based on cross tabulation of the |
| | | quantized vᵢ, and vⱼ. |

(C) Multivariate Relationships

Multivariate relationships define the relationships of individual patients. The result identifies how anomalous a particular patient is with respect to other patients.

More specifically, a distance metric is defined for any pair of patients Pᵢ and Pⱼ. In one embodiment, the distance metric is a weighted version of the Gower distance metric, where the weights are determined by categorizing each variable's importance, relative to demographic variables which have weights 1. For example, in one embodiment variables related to the study drug have weight 2 (reflecting greater than normal importance), and variables related to adverse events have weight 3 (reflecting still greater importance).

With patient distances defined by the distance metric, the model derivation module 220 clusters the patients according to the distances between them. A distance matrix may be formed, enumerating the distances between every pair of patients, as determined with the distance metric. In one embodiment, the model derivation module 220 clusters the patients using multi-dimensional scaling (MDS) based on the distance matrix for the patients. In another embodiment, the model derivation module 220 instead employs hierarchical clustering. The number of patient clusters is then estimated using (a) the reduction of within cluster distance as a function of cluster number, and (b) the stability of the clusters is a function of the distance threshold.

The model derivation module 220 identifies anomalous patients based on their cluster relationships. In one embodiment, the model derivation module 220 flags patients that are in “small” clusters, where “small” is defined either on an absolute basis (e.g., <=N patients for some integer N, such as 5), or a relative basis (e.g., <=N % of all patients, for some number N, such as 2.5). In one embodiment, the model derivation module 220 flags patients that are far from other members of their cluster, where “far” is defined according to a Euclidean distance metric. Specifically, in one embodiment, dimension reduction (e.g., via multi-dimensional scaling (MDS)) is used to convert the patient data records to a reduced data set, and the distances are measured in the context of components of the reduced dimension data (e.g., the first and second MDS components). In one embodiment, a patient is flagged as anomalous unless at least N (e.g., 5) members of the cluster are at less than a threshold distance (e.g., 0.05) from the patient.

The model derivation module 220 additionally identifies potentially fraudulent patients based on the distance matrix for the patients. In one embodiment, the model derivation module 220 flags patient pairs at a clinical site that have a very small pairwise distance, where small is defined either on an absolute basis (e.g., <=d for some distance d, such as 0.01), or a relative basis (e.g., <=q % quantile of all pairwise distances, for some quantile q, such as 0.1%).

### Scoring

The scoring module 230 applies the models 206 derived by the model derivation module 220 to variable values of patient data records of the unified records 202, or to entire patient data records, the result for each data record being an anomaly score indicating a probability that an arbitrary record would have the given values, and therefore indicating whether the values are likely erroneous. Scoring is performed differently, according to the type of model derived by the model derivation module 220.

(A) Univariate Models

Univariate models produce scores for a single variable value. In one embodiment, anomaly scores are computed for univariate models as follows.

For categorical or binary models for a variable, the anomaly score for the value of the variable is computed as sqrt(|2*p(v)|), where sqrt is the square root function, and p(v) is the probability of the variable having the value v across the set of patient data records, as computed earlier through an analysis of the values of the variable over a set of patient data records.

For continuous numeric variables, the anomaly score for the value of the variable is computed as sqrt(|2*p(v)), where p(v)=2*(1−pnorm(|(v−m)/s|)), where v is the value of the variable, m and s are the trimmed mean entry and standard deviation of the variable across the set of patient data records, and pnorm is the function for a normal distribution.

For discrete numeric variables, the anomaly score for the value of the variable is computed as sqrt(|2*p(v)|), where p(v)=2*min(dist(v), 1-dist(v)+density(v)), where dist and density are the cumulative distribution function and density function of the best fitting distribution determined earlier by the model derivation module 220.

In one embodiment, the anomaly score is computed both (a) across the set of all patient data records, and also (b) for each patient cluster determined as part of the multivariate relationships by the model derivation module 220, across the patient data records of that cluster. (The different set of patient data records in (a) and (b) typically lead to different probability functions p(v), and hence typically to different corresponding anomaly scores.)

(B) Bivariate Models

For bivariate models defined by linear regressions, the scoring module 230 computes the standardized residual from the regression standardized_residual=abs((v₁−predicted_v₁)/se(residuals_from_regression_model), where se is the standard error, v₁ is the value of the variable of the first variable and predicted_v₁ is the predicted value of that variable obtained from the regression model. The anomaly score is then computed as sqrt(|2*p(v)|), where p(v)=2*(1−pnorm(standardized_residual)).

For bivariate models derived where the variables are both categorical, or are both binary, the anomaly score for a value pair (v₁,v₂) is sqrt(−2*p(v)|), where p(v) is the larger of the probability that the first variable=v₁ given that the second variable=v₂, and the probability that the second variable=v₂ given that the first variable=v₁

For bivariate models defined by logistic regressions, the anomaly score for a value pair (v, v₂) is the deviance residual=sqrt(|2*p(v)|), where v is the value of the binary variable.

(C) Multivariate Models

The anomaly scores for multivariate models are computed for entire patient data records. In one embodiment, the anomaly scores are binary, indicating whether or not the corresponding patient data records appear anomalous.

Score Aggregation

The scoring module 230 further aggregates the scores produced by the models with respect to individual patient data record values. Specifically, the various individual variables within a given patient data record will have an associated score produced by a corresponding univariate model, and the various pairs of individual variables within a patient data record will have an associated score produced by a corresponding bivariate model. (The individual variables may also be thought of as having the score corresponding to any bivariate model of which that variable is within the corresponding variable pair.) In one embodiment, two scores are calculated for the various variables of the variable pairs: a score from a model derived from the set of all patient data records, and a score from a model derived from only the patient cluster to which the patient data record in question belongs. In this embodiment, the two anomaly scores may be combined into a single overall anomaly score for the variable or variable pair, e.g., by taking the maximum of the two scores, or by averaging the two scores.

The scoring module 230 identifies, as anomalies, scores greater than some threshold value (e.g., 3). In one embodiment, the scoring module 230 produces a report of the identified anomalies and their corresponding anomaly scores.

In one embodiment, the scoring module 230 produces an aggregate anomaly score for each patient data record by computing the percentage of the variables for that patient data record with values that were considered anomalous. Specifically, the scoring module 230 evaluates, for each variable, the corresponding univariate model for (a) all patient data records, and (b) the particular cluster of patient data records to which the patient data record belongs. In one embodiment, the scoring module 230 also increases the anomaly score for a patient data record if the patient data record was considered anomalous based on the cluster relationships derived based on the multivariate relationships. The scoring module 230 additionally evaluates, for each variable, any bivariate models for which the variable is one of the variables of the bivariate model's variable pair. Again, as with univariate models, there is a bivariate model both for (a) all patient data records, and (b) the particular cluster of patient data records to which the patient data record belongs. A variable for which any of these scores—i.e., those of one of the univariate or bivariate models—is above the threshold indicating anomalousness is considered to be anomalous.

In one embodiment, the scoring module 230 produces an aggregate anomaly score for each variable of the patient data records by computing the percentage the set of all patient data records (or of a representative subset thereof) for which the variable's value was considered anomalous.

In one embodiment, the scoring module 230 produces an aggregate anomaly score for each site by computing the percentage of variable values identified as anomalous across all patient data records obtained from that site.

In one embodiment, the scoring module 230 produces an aggregate anomaly score for each variable at each site by computing the percentage of values for that variable identified as anomalous across all patient data records obtained from that site.

In one embodiment, the scoring module 230 produces an aggregate clinical trial anomaly score by calculating the percentage of variable values identified as being anomalous across all patient data records. For example, if there are 1000 variables, and 2000 patents, then there are 2 million distinct patient variable values, and if there were 80,000 such patient variable values identified as being anomalous, then the aggregate clinical trial anomaly score could be calculated as 80,000/2,000,000=4%.

In one embodiment, the scoring module 230 additionally produces a set of average anomaly scores. The average anomaly scores indicate the severity of the anomalies for the values identified as being anomalous, whereas the aggregate anomaly scores indicate the frequency of the anomalies. In one embodiment, the average anomaly score for the set of patients is produced by computing the anomaly scores for the variables across some or all of the patients, identifying those scores sufficiently high to be considered anomalous, and then computing the average of those scores. In one embodiment, the average anomaly score for a variable is produced by identifying, for some or all of the patient data records, whether the variable's value is identified as anomalous, and for those that are considered anomalous, computing the average anomaly score. As a further example, the average anomaly score for a site is produced by computing, for the patient data records produced by a site, the average of the anomaly scores identified as being anomalous for variables over the patient data records produced by the site. As another example, the average anomaly score for the trial as a whole is produced by computing, for the patient data records in the trial (regardless of the site at which they were produced), the average of the anomaly scores identified as being anomalous for the variables of those patient data records.

Grading

The grading module 240 uses the scores produced by the scoring module 230 to assign a grade to the clinical trial as a whole. The assignment of the grade enables those in charge of the clinical trial to quickly determine whether the current data quality of the clinical trial is sufficient, or whether the anomalies require investigation and/or whether more data should be collected. This reduces the expense associated with the clinical trial by enabling those in charge to easily determine whether additional work is needed, or whether the data is now of an acceptable level of quality and hence the data gathering and analysis can cease.

In one embodiment, the aggregate anomaly score for the clinical trial is mapped to a letter grade (or other indicator of data quality, such as a representative image) by partitioning the space of possible aggregate anomaly scores and assigning a letter grade to each. In one embodiment, the partitioning is predetermined, with (for example) aggregate anomaly scores of 0-2% being assigned an ‘A’, 2-3% being assigned a ‘B’, and the like. In another embodiment, the partitioning is empirically determined with respect to prior studies. For example, the aggregate anomaly scores of the prior studies can be computed, and the average aggregate anomaly score of the highest 10% (for example) of the anomaly scores can be used to define the bottom boundary of a first partition corresponding to an ‘A’, the average of the next highest 20% of the anomaly scores used to define the bottom boundary of a second partition corresponding to a ‘B’, and the like.

In one embodiment, the letter grade (or other indicator of data quality) that was determined using the aggregate anomaly score for the trial is adjusted according to the average anomaly score for the trial. This combines both the frequency and the severity of the anomalies when determining the grade. For example, the letter grade determined according to the aggregate anomaly score could be associated with a plus (e.g., “A+”) for average anomaly scores below some threshold, and a minus (e.g., “B−”) for average anomaly scores above some threshold.

In one embodiment, a scaled numeric grade is alternatively or additionally computed. The scaled numeric grade can be computed as (100-10*aggregateAnomalyScore), where aggregateAnomalyScore is the aggregate anomaly score of the clinical trial

In some embodiments, the grading module 240 assigns grades in like manner to entities other than the clinical trial as a whole, such as to individual sites.

### Data Flow

FIG. 3A is a data flow diagram illustrating the process of forming models for assessing likelihoods that errors are present in patient data, according to one embodiment.

The various sites 120 each produce a set of patient data records 121, of which there can be many for a single patient. The unification module 210 of the analysis server 100 combines and standardizes the different patient data records 121, producing a set of unified patient data records 202 containing one record per patient. Each patient data record has a number of associated variables, such as patient height, patient weight, patient daily dose of drug X, and the like.

The model derivation module 220 takes the unified patient data records 202 as input, producing a set of variable clusters 204. Each variable cluster contains a set of variables with sufficiently strong relationships, as determined by a distance between the variables as computed by a distance metric evaluated over some analyzed set of the patient data records 202. For example, the numerical variables “height” and “weight” would typically be placed in the same cluster, since there is a high degree of correlation between them in practice.

Models 206 are trained for the different variables and pairs of variables from the unified patent data records 202. Specifically, a univariate model is derived for each variable, reflecting how anomalous it is for the variable to have a given value. In one embodiment, a number of univariate models are trained for each variable: one is derived from all patient data records 202, and others are derived from the patient data records in the various patient clusters defined by multivariate analysis, one per patient cluster. Additionally, a bivariate model is derived for each pair of variables. In one embodiment, a number of bivariate models are trained for each pair of variables: one is derived from all patient data records 202, and others are derived from the patient data records in the various patient clusters defined by multivariate analysis, one per patient cluster.

FIG. 3B is a data flow diagram illustrating the usage of the models of FIG. 3A to identify potential errors in patient data, according to one embodiment. FIG. 3B illustrates a univariate model 360 and a bivariate model 370. The univariate model is defined with respect to a first patient variable (indicated by the darkening of the first of six variable slots for a simplified example record), and the bivariate model is defined with respect to a second and a fifth patient variable. For a particular patient data record, such as record 355 illustrated in FIG. 3B, the variable value(s) of the record corresponding to the models are provided as input to the models, and the models output anomaly scores. For example, the value of the first variable of record 355 is provided to the univariate model 360, and the output is an anomaly score indicating a degree of anomalousness of that value with respect to other values of the first variable in the other patient data records with respect to which the univariate model 360 was derived.

### Example User Interface

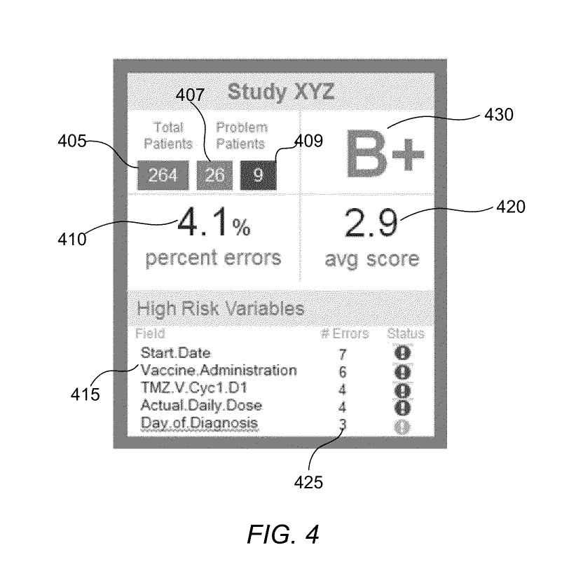

FIG. 4 illustrates a sample user interface showing visual output of the analysis server 100 after analyzing the collected patient data records for a particular clinical trial “XYZ,” according to one embodiment.

Area 264 indicates that there were 264 total patients in the study; area 407 indicates that 26 of these patients were found to be anomalous at a first degree of severity, and area 409 indicates that 9 of these patients were found to be anomalous at a second, higher degree of severity. (The degrees of severity are defined as the aggregate anomaly score for the patient data records.)

Area 415 contains an ordered list of the variables found to be most frequently identified as anomalous over the set of the patient data records in the clinical trial, and area 425 lists the corresponding numbers of times that the variables were identified as being anomalous. For example, the variable “Start Date” was identified as having been found to be anomalous 7 times for the 264 patients in the clinical trial.

Area 410 shows the aggregate anomaly score for the clinical trial (i.e., that 4.1% of the variable values across the set of all the patient data records were identified as being anomalous). Area 420 shows the average anomaly score for the clinical trial (i.e., that of the variable values identified as being anomalous, their average anomaly score was 2.9).

Finally, area 430 indicates the overall grade assigned to the existing data of the clinical trial—i.e., a “B+”, where the “B” is derived from the aggregate anomaly score in area 410, and the “+” is derived from the average anomaly score in area 420, as described above with respect to the grading module 240.

### Example Computer Architecture

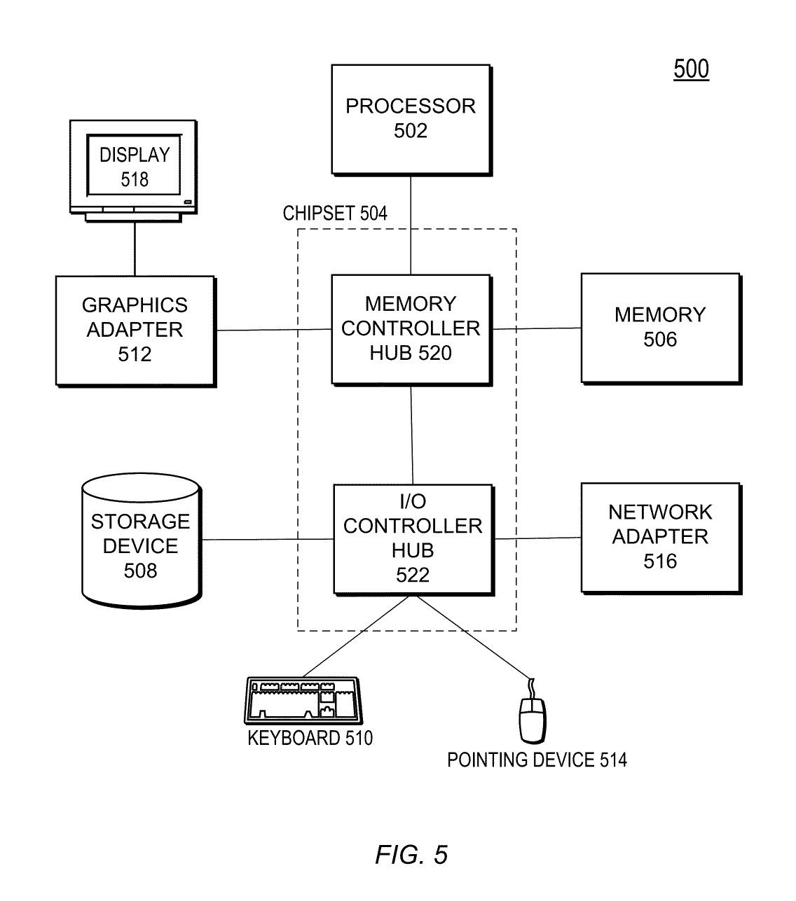

FIG. 5 is a block diagram illustrating physical components of a computer system 500, which can serve as the analysis server 100 of FIG. 1, according to one embodiment. Illustrated are at least one processor 502 coupled to a chipset 504. Also coupled to the chipset 504 are a memory 506, a storage device 408, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer 500. The graphics adapter 512 displays images and other information on the display 518. The network adapter 516 couples the computer system 500 to a local or wide area network.

As is known in the art, a computer system 500 can have different and/or other components than those shown in FIG. 4. In addition, the computer 500 can lack certain illustrated components. For example, in one embodiment, if a computer system 500 is a smartphone it may lack a keyboard 510, pointing device 514, and/or graphics adapter 512, and have a different form of display 518. Moreover, the storage device 508 can be local and/or remote from the computer 500 (such as embodied within a storage area network (SAN)).

As is known in the art, the computer system 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

Embodiments of the entities described herein can include other and/or different modules than the ones described here. In addition, the functionality attributed to the modules can be performed by other or different modules in other embodiments. Moreover, the description occasionally omits the term “module” for purposes of clarity and convenience.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for computing a quality score of data from a clinical trial, comprising:
retrieving, by a computer, patient data records associated with the clinical trial, the patient data records having a plurality of associated patient variables and corresponding to a site that produced the patient data records;
clustering the patient variables into a plurality of clusters;
for a pair of the variables in a cluster, deriving a corresponding bivariate model outputting a score indicating a probability of the first patient variable of the pair having a first given value and the second patient variable of the pair having a second given value;
identifying, within the patient data records using the derived bivariate model, pairs of patient variables having values for which the derived bivariate model outputs a score indicating a low probability; and
calculating a quality score for the clinical trial using a number of the identified patient data records.

2. The computer-implemented method of claim 1, wherein the clustering of the patient variables is based on similarities of values of the patient variables over the patient data records.

3. The computer-implemented method of claim 1, further comprising:
deriving, for each of a plurality of the patient variables, a corresponding univariate model outputting a score indicating a probability of the corresponding patient variable having a given value, the deriving based on values of the corresponding patient variable in the patient data records;
wherein calculating the quality score for the clinical trial additionally uses the univariate models.

4. The computer-implemented method of claim 1, further comprising:
clustering the patient data records into a plurality of patient clusters; and
for the pair of variables in the cluster and for each of a plurality of the patient clusters, deriving a corresponding bivariate model based on the patient data records in the cluster.

5. The computer-implemented method of claim 4, further comprising, for each patient data record of a plurality of patient data records:
identifying a patient cluster corresponding to the patient data record; and
obtaining a score by applying the bivariate model corresponding to the patient cluster to the patient data record;
wherein calculating the quality score for the clinical trial additionally uses the obtained score.

6. The computer-implemented method of claim 1, further comprising:
determining a mapping of clinical trial quality scores to grades based on results of prior clinical trials; and
assigning a grade to the clinical trial using the calculated quality score and the determined mapping.

7. The computer-implemented method of claim 1, further comprising:
for a first site that produced ones of the patient data records:
identifying, within the patient data records produced by the first site, using the computed bivariate model, pairs of patient variables having values for which the computed bivariate model outputs a score indicating a low probability;
computing a quality score for the first site using the pairs of patient variables identified within the patient data records produced by the first site.

8. A computer-implemented method for assigning a quality score to data from a clinical trial, comprising:
retrieving, by a computer, patient data records associated with the clinical trial, the patient data records having a plurality of associated patient variables and corresponding one of a plurality of sites that produced the patient data records;
clustering the patient variables into a plurality of clusters;
for a pair of the variables in a cluster, deriving a corresponding bivariate model outputting a score indicating a probability of the first patient variable of the pair having a first given value and the second patient variable of the pair having a second given value;
identifying, within the patient data records using the derived bivariate model, pairs of patient variables having values for which the derived bivariate model outputs a score indicating a low probability; and
calculating a quality score for one of the sites using a number of the identified patient data records.

9. The computer-implemented method of claim 8, wherein the clustering of the patient variables is based on similarities of values of the patient variables over the patient data records.

10. The computer-implemented method of claim 8, further comprising:
deriving, for each of a plurality of the patient variables, a corresponding univariate model outputting a score indicating a probability of the corresponding patient variable having a given value, the deriving based on values of the corresponding patient variable in the patient data records;
wherein calculating the quality score for the clinical trial additionally uses the univariate models.

11. The computer-implemented method of claim 8, further comprising:
clustering the patient data records into a plurality of patient clusters; and
for the pair of variables in the cluster and for each of a plurality of the patient clusters, deriving a corresponding bivariate model based on the patient data records in the cluster.

12. The computer-implemented method of claim 11, further comprising, for each patient data record of a plurality of patient data records:
identifying a patient cluster corresponding to the patient data record; and
obtaining a score by applying the bivariate model corresponding to the patient cluster to the patient data record;
wherein calculating the quality score for the clinical trial additionally uses the obtained score.

13. The computer-implemented method of claim 8, further comprising:
determining a mapping of quality scores to grades based on results of prior clinical trials; and
assigning a grade to the site using the calculated quality score and the determined mapping.

14. The computer-implemented method of claim 8, further comprising:
identifying, within the patient data records associated with the clinical trial, using the computed bivariate model, pairs of patient variables having values for which the computed bivariate model outputs a score indicating a low probability;
computing a quality score for the clinical trial using the pairs of patient variables identified within the patient data records produced by the first site.

15. A computer-implemented method for assigning a quality grade to data of a clinical trial, comprising:
retrieving, by a computer, patient data records associated with the clinical trial, the patient records having a plurality of associated patient variables and corresponding to a site that produced the patient data records; and
for each pair of a plurality of pairs of the patient variables:
calculating a distance between a first patient variable of the pair and a second patient variable of the pair, based on values of the first patient variable and the second patient variable in the patient data records;
clustering the patient variables into a plurality of clusters based on the calculated distances;
for each cluster of a plurality of the clusters:
computing, for each pair of a plurality of the pairs in the cluster, a corresponding bivariate model outputting a probability of the first patient variable of the pair having a first given value and the second patient variable of the pair having a second given value;
obtaining scores for pairs of the patient variables within the patient data records by applying the models to values of the pairs;
identifying, within the patient data records, pairs of patient variables with a corresponding obtained score indicating improbability of co-occurrence of the values of the patient variables of the pair;
identifying patient data records having more than a threshold number of the identified pairs;
calculating a quality score for the clinical trial using a number of the identified patient records;
determining a grade corresponding to the quality core for the clinical trial; and
outputting the grade for display in a user interface.

16. A non-transitory computer-readable storage medium comprising processor-executable instructions comprising:
instructions for retrieving, by a computer, patient data records associated with the clinical trial, the patient data records having a plurality of associated patient variables and corresponding to a site that produced the patient data records;
instructions for clustering the patient variables into a plurality of clusters;
instructions for for a pair of the variables in a cluster, deriving a corresponding bivariate model outputting a score indicating a probability of the first patient variable of the pair having a first given value and the second patient variable of the pair having a second given value;
instructions for identifying, within the patient data records using the derived bivariate model, pairs of patient variables having values for which the derived bivariate model outputs a score indicating a low probability; and
instructions for calculating a quality score for the clinical trial using a number of the identified patient data records.

17. The non-transitory computer-readable storage medium of claim 16, wherein the clustering of the patient variables is based on similarities of values of the patient variables over the patient data records.

18. The non-transitory computer-readable storage medium of claim 16, further comprising:
instructions for deriving, for each of a plurality of the patient variables, a corresponding univariate model outputting a score indicating a probability of the corresponding patient variable having a given value, the deriving based on values of the corresponding patient variable in the patient data records;
wherein calculating the quality score for the clinical trial additionally uses the univariate models.

19. The non-transitory computer-readable storage medium of claim 16, further comprising:
instructions for clustering the patient data records into a plurality of patient clusters; and
instructions for, for the pair of variables in the cluster and for each of a plurality of the patient clusters, deriving a corresponding bivariate model based on the patient data records in the cluster.

20. The non-transitory computer-readable storage medium of claim 19, further comprising instructions for, for each patient data record of a plurality of patient data records:
identifying a patient cluster corresponding to the patient data record; and
obtaining a score by applying the bivariate model corresponding to the patient cluster to the patient data record;
wherein calculating the quality score for the clinical trial additionally uses the obtained score.
